(19) United States
(12) Patent Application Publication
(10) Pub. No.: US 2026/0207298 A1
(43) Pub. Date: Jul. 23, 2026

(54) Setups Comparison for Final Setups and Intermediate Staging in Clear Tray Aligners

(71) Applicant: Solventum Intellectual Properties Company, Maplewood, MN (US)

(72) Inventors: Seyed Amir Hossein Hosseini, Saint Paul, MN (US); Jonathan D. Gandrud, Woodbury, MN (US); Michael B. Starr, Toomevara (IE); Mariah Sonja Pereira Penha, Dublin (IE); Francis J.T. Yates, Dublin (IE)

(21) Appl. No.: 19/138,807

(22) PCT Filed: Dec. 14, 2023
(86) PCT No.: PCT/IB2023/062700

§ 371 Date: Jun. 13, 2025

Related U.S. Application Data
(60) Provisional application No. 63/432,627, filed on Dec. 14, 2022.
(60) Provisional application No. 63/461,824, filed on Apr. 25, 2023.

(51) Int. Cl. A61C 7/00; A61C 7/08; G06F 30/27

(52) U.S. Cl. CPC A61C 7/002; A61C 7/08; G06F 30/27

(57) ABSTRACT

Systems and techniques for comparing orthodontic setups are disclosed. The method involves receiving an instant orthodontic setup and a reference orthodontic setup, both comprising three-dimensional (3D) representations of one or more teeth. The processing circuitry compares at least one aspect of the instant orthodontic setup with the corresponding aspect of the reference orthodontic setup to compute a comparison metric. The comparison metric represents the degree of similarity or dissimilarity between the two setups. The processing circuitry then outputs the computed comparison metric. These systems and techniques enable efficient and accurate comparison of orthodontic setups, aiding in the evaluation and assessment of treatment plans and facilitating informed decision-making in orthodontic procedures.

### RELATED DOCUMENTS

The entire disclosure of PCT Application No. PCT/IB2022/057373 is incorporated herein by reference. The entire disclosures of each of PCT Applications with Publication Nos. WO2022123402A1, WO2021245480A1, and WO2020026117A1 are incorporated herein by reference. The entire disclosure of each of the following Provisional U.S. Patent Applications is incorporated herein by reference: 63/432,627; 63/366,492; 63/366,495; 63/352,850; 63/366,490; 63/366,494; 63/370,160; 63/366,507; 63/352,877; 63/366,514; 63/366,498; 63/366,514; and 63/264,914.

### TECHNICAL FIELD

This disclosure is generally directed to orthodontic data-targeted algorithms and visualizations for comparing the aspects of two or more orthodontic setups (e.g., a predicted setup and a ground truth setup).

### SUMMARY

Techniques are described to compare orthodontic setups. The compared setups may comprise three-dimensional (3D) representations of teeth, gums or other objects of dental anatomy. Two or more setups may be compared, according to various aspects of this disclosure. The techniques may perform metrics calculation, which may compute statistics between the aspects (e.g., mesh elements) of each of pair of corresponding teeth between the two orthodontic setups. For example, a final setup which is generated by a setups prediction machine learning model may be compared to a reference setup (e.g., a ground truth final setup which has been reviewed or approved by a clinician). Such a comparison is valuable to the process of developing a setups prediction machine learning model, because different model and algorithmic designs may be evaluated. The impacts of different machine learning training conditions, parameters and datasets can be evaluated by comparing predicted setups to ground truth setups which have been reviewed by technicians or clinicians.

In other examples, a first version final setup generated by a setups prediction machine learning model may be compared to a second version final setup which is generated by the setups prediction machine learning model (e.g., to reveal information aspects of the two setups). In the latter case, a clinician may configure the setups prediction machine learning model to output a setup with a first configuration (e.g., by setting one or more oral care arguments (e.g., oral care metrics or oral care parameters) which are taken as input to the setups prediction model), yielding the first predicted setup. The clinician may configure the setups prediction ML model to output a setup with a second configuration (e.g., the second predicted setup), using a different value for at least one of the received oral care arguments. The setups prediction neural network may be trained to produce output in response to specific oral care arguments received as input data. The comparison techniques described herein may be used to detect and analyze differences between the two or more configurations, thereby improving the understanding of the impact of the chosen oral care arguments and enabling better setups to be produced. Such setups may be used in the production of oral care appliances, such as clear tray aligners (CTAs).

According to some implementations, the systems of this disclosure may compare two or more final setups which reflect the target poses of the teeth of the arch, for application to orthodontic treatment. Some implementations may compare two or more intermediate stages, which reflect the poses of the teeth of the arch in between the starting (mal) and final poses, for application to orthodontic treatment. Setups comparisons techniques of this disclosure may, in some instances, be performed between two or more of malocclusion, staging, or final setups examples (e.g., comparing a mal setup to a ground truth approved final setup, etc.).

Methods of this disclosure may compare an instant orthodontic setup to a reference orthodontic setup. For example, the methods may compute a comparison metric between corresponding aspects of the instant setup and the reference setup. In some examples, the methods may train a machine learning model to compare two or more setups. In some implementations, the methods may provide one or more computed comparison metric values as feedback to a machine learning (ML) model that generated the instant orthodontic setup (e.g., a setups prediction model). In some implementations, a comparison metric may be provided to an optimizer that is configured to implement iterative changes to an input orthodontic setup. In some instances, the instant orthodontic setup represents one or more teeth in transformed poses. In some instances, the instant orthodontic setup may represent one or more teeth which are initially at an origin of a global coordinate space, and are then transformed into the instant orthodontic setup prior to computing the comparison metric. In some implementations, a comparison metric is used to generate an orthodontic appliance design (e.g., the metric may be provided to the input of a setups prediction model or other ML model). In some implementations, a comparison metric may be computed using an iterative closest point (ICP)-based technique. A mesh element is an example of an aspect of the instant orthodontic mesh or of the corresponding aspect of the reference orthodontic mesh. An example comparison metric may, in some implementations, include an angular distance between a vector of the instant orthodontic setup and a corresponding vector of the reference orthodontic setup. In some implementations, each of the vector and the corresponding vector may contain at least one respective coordinate axis. Some metrics may compute an angular difference, such as a cosine difference or a dot product. The methods may, in some implementations, be deployed at a clinical context.

### BRIEF DESCRIPTION OF DRAWINGS

FIG. 1 shows methods of measuring the difference between tooth meshes, in accordance with aspects of this disclosure.

FIG. 2 shows the output of a 3D viewer application for viewing and comparing two or more setups.

FIG. 3 show statistics for metrics which may be computed to compare two or more setups.

FIG. 4 shows a method of comparing two or more setups.

FIG. 5 shows a visualization of a comparison of orthodontic setups generated according to various methods.

FIG. 6 shows a machine learning (ML) method to compare two or more setups.

### DETAILED DESCRIPTION

Systems of this disclosure may automate operations in digital orthodontics (e.g., setups prediction, hardware placement, setups comparison), in digital dentistry (e.g., restoration design generation) or in combinations thereof. Some techniques may apply to either or both of digital orthodontics and digital dentistry. A non-limiting list of examples is as follows: segmentation, mesh cleanup, coordinate system prediction, oral care mesh validation, imputation of oral care parameters, oral care mesh generation or modification (e.g., using autoencoders, transformers, continuous normalizing flows or denoising diffusion models, etc.), metrics visualization, appliance component placement or appliance component generation or the like. In some instances, systems of this disclosure may enable a clinician or technician to process oral care data (such as scanned dental arches). In addition to segmentation, mesh cleanup, coordinate system prediction or validation operations, the systems of this disclosure may enable orthodontic treatment planning, which may involve setups prediction as at least one operation. Systems of this disclosure may also enable restoration design generation, where one or more restored tooth designs are generated and processed in the course of creating oral care appliances. Systems of this disclosure may enable either or both of orthodontic or dental treatment planning, or may enable automation steps in the generation of either or both of orthodontic or dental appliances. Some appliances may enable both of dental and orthodontic treatment, while other appliances may enable one or the other.

This disclosure pertains to digital oral care, which encompasses the fields of digital dentistry and digital orthodontics. This disclosure generally describes methods of processing three-dimensional (3D) representations of oral care data. It should be understood, without loss of generality, that there are various types of 3D representations. One type of 3D representation is a 3D geometry. A 3D representation may include, be, or be part of one or more of a 3D polygon mesh, a 3D point cloud (e.g., such as derived from a 3D mesh), a 3D voxelized representation (e.g., a collection of voxels—for sparse processing), or 3D representations which are described by mathematical equations. Although the term “mesh” is used frequently throughout this disclosure, the term should be understood, in some implementations, to be interchangeable with other types of 3D representations. A 3D representation may describe elements of the 3D geometry and/or 3D structure of an object.

Dental arches S1, S2, S3 and S4 all contain the exact same tooth meshes, but those tooth meshes are transformed differently, according to the following description. A first arch S1 includes a set of tooth meshes arranged (e.g., using transforms) in their positions in the mouth, where the teeth are in the mal positions and orientations. A second arch S2 includes the same set of tooth meshes from S1 arranged (e.g., using transforms) in their positions in the mouth, where the teeth are in the ground truth setup positions and orientations. A third arch S3 includes the same meshes as S1 and S2, which are arranged (e.g., using transforms) in their positions in the mouth, where the teeth are in the predicted final setup poses (e.g., as predicted by one or more of the techniques of this disclosure). S4 is a counterpart to S3, where the teeth are in the poses corresponding to one of the several intermediate stages of orthodontic treatment with clear tray aligners.

It should be understood, without the loss of generality, that the techniques of this disclosure which apply to final setups are also applicable to intermediate staging in orthodontic treatment, particularly geometric deep learning (GDL) Setups, reinforcement learning (RL) Setups, variational autoencoder (VAE) Setups, Capsule Setups, multilayer perceptron (MLP) Setups, Diffusion Setups, pose transfer (PT) Setups, Similarity Setups, force directed graphs (FDG) Setups, Transformer Setups, Setups Comparison, or Setups Classification. The Metrics Visualization aspects of this disclosure may also be configured to visualize data from both final setups and intermediate stages. MLP Setups, VAE Setups and Capsule Setups each fall within the scope of Autoencoder Setups. Some implementations of MLP Setups may fall within the Scope of Transformer Setups. Representation Setups refers to any of MLP Setups, VAE Setups, Capsule Setups and any other setups prediction machine learning model which uses an autoencoder to create the representation for at least one tooth.

Each of the setups prediction techniques of this disclosure is applicable to the fabrication of clear tray aligners and/or indirect bonding trays. The setups predictions techniques may also be applicable to other products that involve final teeth poses, also. A pose may comprise a position (or location) and a rotation (or orientation).

A 3D mesh is a data structure which may describe the geometry or shape of an object related to oral care, including but not limited to a tooth, a hardware element, or a patient's gum tissue. A 3D mesh may include one or more mesh elements such as one or more of vertices, edges, faces and combinations thereof. In some implementations, mesh element may include voxels, such as in the context of sparse mesh processing operations. Various spatial and structural features may be computed for these mesh elements and be provided to the predictive models of this disclosure, with the predictive models of this disclosure providing the technical advantage of improving data precision in the form of the models of this disclosure outputting more accurate predictions.

A patient's dentition may include one or more 3D representations of the patient's teeth (e.g., and/or associated transforms), gums and/or other oral anatomy. An orthodontic metric (OM) may, in some implementations, quantify the relative positions and/or orientations of at least one 3D representation of a tooth relative to at least one other 3D representation of a tooth. A restoration design metric (RDM) may, in some implementations, quantify the at least one aspect of the structure and/or shape of a 3D representation of a tooth. An orthodontic landmark (OL) may, in some implementations, locate one or more points or other structural regions of interest on a 3D representation of a tooth. An OL may, in some implementations, be used in the generation of an orthodontic or dental appliance, such as a clear tray aligner or a dental restoration appliance. A mesh element may, in some implementations, comprise at least one constituent element of a 3D representation of oral care data. For example, in the case of a tooth that is represented by a 3D mesh, mesh elements may include at least: vertices, edges, faces and voxels. A mesh element feature may, in some implementations, quantify some aspect of a 3D representation in proximity to or in relation with one or more mesh elements, as described elsewhere in this disclosure. Orthodontic procedure parameters (OPP) may, in some implementations, specify at least one value which defines at least one aspect of planned orthodontic treatment for the patient (e.g., specifying desired target attributes of a final setup in final setups prediction). Orthodontic Doctor preferences (ODP) may, in some implementations, specify at least one typical value for an OPP, which may, in some instances, be derived from past cases which have been treated by one or more oral care practitioners. Restoration Design Parameters (RDP) may, in some implementations, specify at least one value which defines at least one aspect of planned dental restoration treatment for the patient (e.g., specifying desired target attributes of a tooth which is to undergo treatment with a dental restoration appliance). Doctor Restoration Design Preferences (DRDP) may, in some implementations, specify at least one typical value for an RDP, which may, in some instances, be derived from past cases which have been treated by one or more oral care practitioners. 3D oral care representations may include, but are not limited to: 1) a set of mesh element labels which may be applied to the 3D mesh elements of teeth/gums/hardware/appliance meshes (or point clouds) in the course of mesh segmentation or mesh cleanup; 2) 3D representation(s) for one or more teeth/gums/hardware/appliances for which shapes have been modified (e.g., trimmed, distorted, or filled-in) in the course of mesh segmentation or mesh cleanup; 3) one or more coordinate systems (e.g., describing one, two, three or more coordinate axes) for a single tooth or a group of teeth (such as a full arch—as with the LDE coordinate system); 4) 3D representation(s) for one or more teeth for which shapes have been modified or otherwise made suitable for use in dental restoration; 5) 3D representation(s) for one or more dental restoration appliance components; 6) one or more transforms to be applied to one or more of: dental restoration appliance library component placement relative to one or more teeth, a tooth to be placed for an orthodontic setup (either final setup or intermediate stage), a hardware element to be placed relative to one or more teeth or the like; 7) an orthodontic setup; 8) a 3D representation of a hardware element (such as facial bracket, lingual bracket, orthodontic attachment, button, hook, bite ramp, etc.) to be placed relative to one or more teeth, etc.; 8) a 3D representation of a bonding pad for a hardware element (which may be generated for a specific tooth by outlining a perimeter on the tooth, specifying a thickness to form a shell, and then subtracting-out the tooth via a Boolean operation); 9) 3D representation of a clear tray aligner (CTA); 10) the location or shape of a CTA trimline (e.g., described as either a mesh or polyline); 11) archform that describes the contours or layout of an arch of teeth (e.g., described as a 3D polyline or as a 3D mesh or surface), which may follow the incisal edges one or more teeth, which may follow the facial surfaces of one or more teeth, which may in some implementations correspond to the maloccluded arch and in other implementations correspond to the final setup arch (the effects of malocclusion on the shape of the archform may be diminished by smoothing or averaging of the shape of the archform), which may be described by one or more control points and/or a spline; 12) 3D representation of a fixture models (e.g., depictions of teeth and gums for use in thermoforming clear tray aligners, or depictions of teeth/gums/hardware for use in thermoforming indirect bonding trays); 13) one or more latent space vectors (or latent capsules) produced by the 3D encoder stage of a 3D autoencoder which has been trained on the reconstruction of oral care meshes (e.g., a variational autoencoder which has been trained for tooth reconstruction); 14) one or more oral care metrics values (e.g., such as orthodontic metrics or restoration design generation metrics) for one or more teeth; 15) one or more landmarks (e.g., 3D points) which describe the shapes and/or geometrical attributes of one or more teeth, other dentition structures or hardware structures (e.g., to be used in orthodontic setups creation or restoration appliance component generation or placement); 16) 3D representation created by scanning (e.g., optically scanning, CT scanning or MRI scanning) a 3D printed part corresponding to one or more teeth/gums/hardware/appliances (e.g., a scanned fixture model); 17) 3D printed aligners (including optionally local thickness, reinforcing rib geometry, flap positioning, or the like) 18) 3D representation of the patient's dentition that was captured chairside by a clinician or medical practitioner (e.g., in a context where the 3D representation is validated chairside, before the patient leaves the clinic, so that errors can be detected and re-scans performed as necessary); 19) dental restoration tooth design (e.g., for veneers, crowns, bridges or dental restoration appliances); 20) 3D representations of one or more teeth for use in digital oral care treatment; 21) other 3D printed parts pertaining to oral care procedures or other fields; 22) IPR cut surfaces; 23) one or more orthodontic setups transforms associated with one or more IPR cut surfaces; 24) a (digital) pontic tooth design which may fill at least a portion of the space between teeth to allow room in an orthodontic setup for an erupting tooth to later emerge from the gums; or 25) a component of a fixture model (e.g., comprising fixture model components such as interproximal webbing, block-out, bite locks, bite ramps, interproximal reinforcement, gingival ridges, torque points, power ridges, pontic tooth or dimples, among others).

Systems of this disclosure may, in some instances, be deployed at a clinical context (such as a dental or orthodontic office) for use by clinicians (e.g., doctors, dentists, orthodontists, nurses, hygienists, oral care technicians). Such systems which are deployed at a clinical context may enable clinicians to process oral care data (such as dental scans) in the clinic environment, or in some instances, in a “chairside” context (where the patient is present in the clinical environment). A non-limiting list of examples of techniques may include: segmentation, mesh cleanup, coordinate system prediction, CTA trimline generation, restoration design generation, appliance component generation or placement or assembly, generation of other oral care meshes, the validation of oral care meshes, setups prediction, removal of hardware from tooth meshes, hardware placement on teeth, imputation of missing values, clustering on oral care data, oral care mesh classification, setups comparison, metrics calculation, or metrics visualization. The execution of these techniques may, in some instances, enable patient data to be processed, analyzed and used in appliance generation by the clinician before the patient leaves the clinical environment (which may facilitate treatment planning because feedback may be received from the patient during the treatment planning process).

Systems of this disclosure may automate operations in digital orthodontics (e.g., setups prediction, hardware placement, setups comparison), in digital dentistry (e.g., restoration design generation) or in combinations thereof. Some techniques may apply to either or both of digital orthodontics and digital dentistry. A non-limiting list of examples is as follows: segmentation, mesh cleanup, coordinate system prediction, oral care mesh validation, imputation of oral care parameters, oral care mesh generation or modification (e.g., using autoencoders or transformers), metrics visualization, appliance component placement or appliance component generation or the like. In some instances, systems of this disclosure may enable a clinician or technician to process oral care data (such as scanned dental arches). In addition to segmentation, mesh cleanup, coordinate system prediction or validation operations, the systems of this disclosure may enable orthodontic treatment planning, which may involve setups prediction as at least one operation. Systems of this disclosure may also enable restoration design generation, where one or more restored tooth designs are generated and processed in the course of creating oral care appliances. Systems of this disclosure may enable either or both of orthodontic or dental treatment planning, or may enable automation steps in the generation of either or both of orthodontic or dental appliances. Some appliances may enable both of dental and orthodontic treatment, while other appliances may enable one or the other.

Techniques of this disclosure may require a training dataset of hundreds or thousands of cohort patient cases, to ensure that the neural network is able to encode the distribution of patient cases which are likely to be encountered in clinical treatment. A cohort patient case may include a set of tooth crown meshes, a set of tooth root meshes, or a data file containing attributes of the case (e.g., a JSON file). A typical example of a cohort patient case may contain up to 32 crown meshes (e.g., which may each contain tens of thousands of vertices or tens of thousands of faces), up to 32 root meshes (e.g., which may each contain tens of thousands of vertices or tens of thousands of faces), multiple gingiva mesh (e.g., which may each contain tens of thousands of vertices or tens of thousands of faces) or one or more JSON files which may each contain tens of thousands of values (e.g., objects, arrays, strings, real values, Boolean values or Null values).

Aspects of the present disclosure can provide a technical solution to the technical problem of comparing, using mesh processing techniques, two or more orthodontic setups for use in oral care appliance generation, visualizing setups, or predictive ML model selection (e.g., choosing between the setups generated by two or more predictive model configurations). In particular, by practicing techniques disclosed herein computing systems specifically adapted to perform setups comparison as a part of oral care appliance generation are improved. For example, aspects of the present disclosure improve the performance of a computing system having a 3D representation of the patient's dentition by reducing the consumption of computing resources. In particular, aspects of the present disclosure reduce computing resource consumption by decimating 3D representations of the patient's dentition (e.g., reducing the counts of mesh elements used to describe aspects of the patient's dentition) so that computing resources are not unnecessarily wasted by processing excess quantities of mesh elements. Additionally, decimating the meshes does not reduce the overall predictive accuracy of the computing system (and indeed may actually improve predictions because the input provided to the ML model after decimation is a more accurate (or better) representation of the patient's dentition). For example, noise or other artifacts which are unimportant (and which may reduce the accuracy of the predictive models) are removed. That is, aspects of the present disclosure provide for more efficient allocation of computing resources and in a way that improves the accuracy of the underlying system.

Furthermore, aspects of the present disclosure may need to be executed in a time-constrained manner, such as when an oral care appliance must be generated for a patient immediately after intraoral scanning (e.g., while the patient waits in the clinician's office). As such, aspects of the present disclosure are necessarily rooted in the underlying computer technology of setups comparison and visualization and cannot be performed by a human, even with the aid of pen and paper. For instance, implementations of the present disclosure must be capable of: 1) storing thousands or millions of mesh elements of the patient's dentition in a manner that can be processed by a computer processor; 2) performing calculation on thousands or millions of mesh elements, e.g., to quantify aspects of the shape and or/structure of an individual tooth in the 3D representation of the patient's dentition; 3) visualizing thousands or millions of mesh elements of the two or more setups in a manner that highlights differences and/or similarities 4) computing thousands or millions of operations on the two or more setups to quantify differences in the shape and/or structure of the two or more setups, and using the comparison in oral care appliance generation, and do so during the course of a short office visit.

The techniques of this disclosure may be advantageously combined. For example, the Setups Comparison tool may be used to compare the output of the GDL Setups model against ground truth data, compare the output of the RL Setups model against ground truth data, compare the output of the VAE Setups model against ground truth data and compare the output of the MLP Setups model against ground truth data. With each of these setups prediction models compared against ground truth data, it may be possible to determine which model gives the best performance on a certain dataset or within a given problem domain. Furthermore, the Metrics Visualization tool can enable a global view of the final setups and intermediate stages produced by one or more of the setups prediction models, with the advantage of enabling the selection of the best setups prediction model. The Metrics Visualization tool, furthermore, enables the computation of metrics which have a global scope over a set of intermediate stages. These global metrics may, in some implementations, be consumed as inputs to the neural networks for predicting setups (e.g., GDL Setups, RL Setups, VAE Setups, Capsule Setups, MLP Setups, Diffusion Setups, PT Setups, Similarity Setups, among others). The global metrics may also be provided to force-directed graph (FDG)-based setups generation tools. The local metrics from this disclosure (i.e., a local metric is a metric which may be computed for one stage or setup of treatment, rather than over several stages or setups) may, in some implementations, be consumed by the neural networks herein for predicting setups, with the advantage of improving predictive results. The metrics described in this disclosure may, in some implementations, be visualized using the Metric Visualization tool.

The VAE and MAE models for mesh element labelling and mesh in-filling can be advantageously combined with the setups prediction neural networks, for the purpose of mesh cleanup ahead of or during the prediction process. In some implementations, the VAE for mesh element labelling may be used to flag mesh elements for further processing, such as metrics calculation, removal or modification. In some instances, such flagged mesh elements may be provided as inputs to a setups prediction neural network, to inform that neural network about important mesh features, attributes or geometries, with the advantage of improving the performance of the resulting setups prediction model. In some implementations, mesh in-filling may cause the geometry of a tooth to become more nearly complete, enabling the better functioning of a setups prediction model (i.e., improved correctness of prediction on account of better-formed geometry). In some instances, a neural network to classify a setup (i.e., the Setups Classifier) may aid in the functioning of a setups prediction neural network, because the setups classifier tells that setups prediction neural network when the predicted setup is acceptable for use and can be provided to a method for aligner tray generation. A Setups Classifier (e.g., GDL Setups, RL Setups, VAE Setups, Capsule Setups, MLP Setups, Diffusion Setups, PT Setups, Similarity Setups and FDG Setups, among others) may aid in the generation of final setups and also in the generation of intermediate stages. Furthermore, a Setups Classifier neural network may be combined with the Metrics Visualization tool. In other implementations, a Setups Classification neural network may be combined with the Setups Comparison tool (e.g., the Setup Comparison tool may output an indication of how a setup produced in part by the Setups Classifier compares to a setup produced by another setups prediction method). In some implementations, the VAE for mesh element labelling may identify one or more mesh elements for use in a metrics calculation. The resulting metrics outputs may be visualized by the Metrics Visualization tool.

In some examples, the Setups Classifier neural network may aid in the setups prediction technique described in U.S. Patent Application No. US20210259808A1 (which is incorporated herein by reference in its entirety) or the setups prediction technique described in PCT Application with Publication No. WO2021245480A1 (which is incorporated herein by reference in its entirety) or in PCT Application No. PCT/IB2022/057373 (which is incorporated herein by reference in its entirety). The Setups Classifier would help one or more of those techniques to know when the predicted final setup is most nearly correct. In some instances, the Setups Classifier neural network may output an indication of how far away from final setup a given setup is (i.e., a progress indicator).

In some implementations, the latent space embedding vector(s) from the reconstruction VAE can be concatenated with the inputs to the setups prediction neural network described in WO2021245480A1. The latent space vectors can also be incorporated as inputs to the other setups prediction models: GDL Setups, RL Setups, VAE Setups, Capsule Setups, MLP Setups and Diffusion Setups, among others. The advantage is to impart the reconstruction characteristics (e.g., latent vector dimensions of a tooth mesh) to that neural network, hence improving the generated setups prediction.

In some examples, the various setups prediction neural networks of this disclosure may work together to produce the setups required for orthodontic treatment. For example, the GDL Setups model may produce a final setup, and the RL Setups model may use that final setup as input to produce a series of intermediate stages setups. Alternatively, the VAE Setups model (or the MLP Setups model) may create a final setup which may be used by a RL Setups model to produce a series of intermediate stages setups. In some implementations, a setup prediction may be produced by one setups prediction neural network, and then taken as input to another setups prediction neural network for further improvements and adjustments to be made. In some implementations, such improvements may be performed in iterative fashion.

In some implementations, a setups validation model, such as the model disclosed in U.S. Provisional Application No. 63/366,495, may be involved in this iterative setups prediction loop. First a setup may be generated (e.g., using a model trained for setups prediction, such as GDL Setups, RL Setups, VAE Setups, Capsule Setups, MLP Setups, Diffusion Setups, PT Setups, Similarity Setups and FDG Setups, among others), then the setup undergoes validation. If the setup passes validation, the setup may be outputted for use. If the setup fails validation, the setup may be sent back to one or more of the setups prediction models for corrections, improvements and/or adjustments. In some instances, the setups validation model may output an indication of what is wrong with the setup, enabling the setups generation model to make an improved version upon the next iteration. The process iterates until done.

Generally speaking, in some implementations, two or more of the following techniques of the present disclosure may be combined in the course of orthodontic and/or dental treatment: GDL Setups, Setups Classification, Reinforcement Learning (RL) Setups, Setups Comparison, Autoencoder Setups (VAE Setups or Capsule Setups), VAE Mesh Element Labeling, Masked Autoencoder (MAE) Mesh In-filling, Multi-Layer Perceptron (MLP) Setups, Metrics Visualization, Imputation of Missing Oral Care Parameters Values, Tooth Classification Using Latent Vector, FDG Setups, Pose Transfer Setups, Restoration Design Metrics Calculation, Neural Network Techniques for Dental Restoration and/or Orthodontics (e.g., 3D Oral Care Representation Generation or Modification Using Transformers), Landmark-based (LB) Setups, Diffusion Setups, Imputation of Tooth Movement Procedures, Capsule Autoencoder Segmentation, Diffusion Segmentation, Similarity Setups, Validation of Oral Care Representations (e.g., using autoencoders), Coordinate System Prediction, Restoration Design Generation or 3D Oral Care Representation Generation or Modification Using Denoising Diffusion Models.

A 3D representation may be produced using a 3D scanner, such as an intraoral scanner, a computerized tomography (CT) scanner, ultrasound scanner, a magnetic resonance imaging (MRI) machine or a mobile device which is enabled to perform stereophotogrammetry. A 3D representation may describe the shape and/or structure of a subject. A 3D representation may include one or more 3D mesh, 3D point cloud, and/or a 3D voxelized representation, among others. A 3D mesh includes edges, vertices, or faces. Though interrelated in some instances, these three types of data are distinct. The vertices are the points in 3D space that define the boundaries of the mesh. These points would alternatively be described as a point cloud but for the additional information about how the points are connected to each other, as described by the edges. An edge is described by two points and can also be referred to as a line segment. A face is described by a number of edges and vertices. For instance, in the case of a triangle mesh, a face comprises three vertices, where the vertices are interconnected to form three contiguous edges. Some meshes may contain degenerate elements, such as non-manifold mesh elements, which may be removed, to the benefit of later processing. Other mesh pre-processing operations are possible in accordance with aspects of this disclosure. 3D meshes are commonly formed using triangles, but may in other implementations be formed using quadrilaterals, pentagons, or some other n-sided polygon. In some implementations, a 3D mesh may be converted to one or more voxelized geometries (i.e., comprising voxels), such as in the case that sparse processing is performed. The techniques of this disclosure which operate on 3D meshes may receive as input one or more tooth meshes (e.g., arranged in one or more dental arches). Each of these meshes may undergo pre-processing before being input to the predictive architecture (e.g., including at least one of an encoder, decoder, pyramid encoder-decoder and U-Net). This pre-processing may include the conversion of the mesh into lists of mesh elements, such as vertices, edges, faces or in the case of sparse processing-voxels. For the chosen mesh element type or types, (e.g., vertices), feature vectors may be generated. In some examples, one feature vector is generated per vertex of the mesh. Each feature vector may contain a combination of spatial and/or structural features, as specified in the following table:

TABLE 1

| Element | Spatial Features | Structural Features |
|---|---|---|
| Edges | XYZ position | Edge curvature (depends on a |
| | of an edge | connectivity neighborhood, |
| | midpoint, XYZ | average curvature of two |
| | positions of the | vertices), dihedral angles, edge |
| | edge vertices, | length, density measure such as |
| | or the normal | a count of incident edges (i.e., a |
| | vector at an | count of the other neighboring |
| | edge midpoint | edges which share the vertices |
| | (average of the | of that edge). |
| | normal vectors | |
| | of two vertices). | |
| Faces | XYZ position of a | Face curvature (average |
| | face centroid, | curvature of the vertices of the |
| | surface normal | face), face area, density measure |
| | vector. | such as count of adjacent faces |
| | | (i.e., which share at least one |
| | | edge with the face). |
| Points | XYZ position | Density measure such as the |
| | | count of neighboring points |
| | | within a radius of the point |
| Vertices | XYZ position, | Vertex curvature, density |
| | normal vector | measure such as the count of |
| | (weighted average | vertices within a radius of the |
| | of the normal | vertex, density measure such as |
| | vectors of the | the count of incident edges. |
| | connecting faces | |
| | for the vertex). | |
| Voxels | XYZ centroid. | Volume, [height × depth × width] |
| | | dimensions, density measure |
| | | such as a count of contained |
| | | vertices, density measure such as |
| | | count of intersected faces, |
| | | density measure such as count of |
| | | intersected edges. |

Table 1 discloses non-limiting examples of mesh element features. In some implementations, color (or other visual cues/identifiers) may be considered as a mesh element feature in addition to the spatial or structural mesh element features described in Table 1. As used herein (e.g., in Table 1), a point differs from a vertex in that a point is part of a 3D point cloud, whereas a vertex is part of a 3D mesh and may have incident faces or edges. A dihedral angle (which may be expressed in either radians or degrees) may be computed as the angle (e.g., a signed angle) between two connected faces (e.g., two faces which are connected along an edge). A sign on a dihedral angle may reveal information about the convexity or concavity of a mesh surface. For example, a positively signed angle may, in some implementations, indicate a convex surface. Furthermore, a negatively signed angle may, in some implementations, indicate a concave surface. To calculate the principal curvature of a mesh vertex, directional curvatures may first be calculated to each adjacent vertex around the vertex. These directional curvatures may be sorted in circular order (e.g., 0, 49, 127, 210, 305 degrees) in proximity to the vertex normal vector and may comprise a subsampled version of the complete curvature tensor. Circular order means: sorted in by angle around an axis. The sorted directional curvatures may contribute to a linear system of equations amenable to a closed form solution which may estimate the two principal curvatures and directions, which may characterize the complete curvature tensor. Consistent with Table 1, a voxel may also have features which are computed as the aggregates of the other mesh elements (e.g., vertices, edges and faces) which either intersect the voxel or, in some implementations, are predominantly or fully contained within the voxel. Rotating the mesh may not change structural features but may change spatial features. And, as described elsewhere in this disclosure, the term “mesh” should be considered in a non-limiting sense to be inclusive of 3D mesh, 3D point cloud and 3D voxelized representation. In some implementations, apart from mesh element features, there are alternative methods of describing the geometry of a mesh, such as 3D keypoints and 3D descriptors. Examples of such 3D keypoints and 3D descriptors are found in “TONIONI A, et al. in ‘Learning to detect good 3D keypoints.’, Int J Comput. Vis. 2018 Vol. 126, pages 1-20.”. 3D keypoints and 3D descriptors may, in some implementations, describe extrema (either minima or maxima) of the surface of a 3D representation. In some implementations, one or more mesh element features may be computed, at least in part, via deep feature synthesis (DFS), e.g. as described in: J. M. Kanter and K. Veeramachaneni, “Deep feature synthesis: Towards automating data science endeavors,” 2015 IEEE International Conference on Data Science and Advanced Analytics (DSAA), 2015, pp. 1-10, doi: 10.1109/DSAA.2015.7344858.

Representation generation neural networks based on autoencoders, U-Nets, transformers, other types of encoder-decoder structures, convolution and/or pooling layers, or other models may benefit from the use of mesh element features. Mesh element features may convey aspects of a 3D representation's surface shape and/or structure to the neural network models of this disclosure. Each mesh element feature describes distinct information about the 3D representation that may not be redundantly present in other input data that are provided to the neural network. For example, a vertex curvature may quantify aspects of the concavity or convexity of the surface of a 3D representation which would not otherwise be understood by the network. Stated differently, mesh element features may provide a processed version of the structure and/or shape of the 3D representation; data that would not otherwise be available to the neural network. This processed information is often more accessible, or more amenable for encoding by the neural network. A system implementing the techniques disclosed herein has been utilized to run a number of experiments on 3D representations of teeth. For example, mesh element features have been provided to a representation generation neural network which is based on a U-Net model, and also to a representation generation model based on a variational autoencoder with continuous normalizing flows. Based on experiments, it was found that systems using a full complement of mesh element features (e.g., “XYZ” coordinates tuple, “Normal vector”, “Vertex Curvature”, Points-Pivoted, and Normals-Pivoted) were at least 3% more accurate than systems that did not. Points-Pivoted describes “XYZ” coordinates tuples that have local coordinate systems (e.g., at the centroid of the respective tooth). Normals-Pivoted describes “Normal Vectors” which have local coordinate systems (e.g., at the centroid of the respective tooth). Furthermore, training converges more quickly when the full complement of mesh element features are used. Stated another way, the machine learning models trained using the full complement of mesh element features tended to be more accurate more quickly (at earlier epochs) than systems which did not. For an existing system observed to have a historical accuracy rate of 91%, an improvement in accuracy of 3% reduces the actual error rate by more than 30%.

Predictive models which may operate on feature vectors of the aforementioned features include but are not limited to: GDL Setups, RL Setups, VAE Setups, Capsule Setups, MLP Setups, Diffusion Setups, other Denoising Diffusion Models, PT Setups, Similarity Setups, Tooth Classification, Setups Classification, Setups Comparison, VAE Mesh Element Labeling, MAE Mesh In-filling, Mesh Reconstruction Autoencoder, Validation Using Autoencoders, Mesh Segmentation, Coordinate System Prediction, Mesh Cleanup, Restoration Design Generation, Appliance Component Generation and/or Placement, and Archform Prediction. Such feature vectors may be presented to the input of a predictive model. In some implementations, such feature vectors may be presented to one or more internal layers of a neural network which is part of one or more of those predictive models.

Representation generation neural networks based on autoencoders, U-Nets, transformers, other types of encoder-decoder structures, convolution and/or pooling layers, or other models may benefit from the use of oral care arguments (e.g., oral care metrics or oral care parameters). For example, oral care metrics (e.g., orthodontic metrics or restoration design metrics) may convey aspects of the shape and/or structure of the patient's dentition (e.g., the shape and/or structure of an individual tooth, or the special relationships between two or more teeth) to the neural network models of this disclosure. Each oral care metric describes distinct information about the patient's dentition that may not be redundantly present in other input data that are provided to the neural network. For example, an “Overbite” metric may quantify the overlap between the upper and lower central incisors along the vertical Z-axis, information which may not otherwise, in some implementations, be readily ascertainable by a traditional neural network. Stated another way, the oral care metrics provide refined information about the patient's dentition that a traditional neural network (e.g., a representation generation neural network) may not be adequately trained or configured to extract. However, a neural network which is specifically trained to generate oral care metrics may overcome such a shortcoming, because, for example loss may be computed in such a way as to facilitate accurate oral care metrics prediction. Mesh oral care metrics may provide a processed version of the structure and/or shape of the patient's dentition, data which may not otherwise be available to the neural network. This processed information is often more accessible, or more amenable for encoding by the neural network. A system implementing the techniques disclosed herein has been utilized to run a number of experiments on 3D representations of teeth. For example, oral care metrics have been provided to a representation generation neural network which is based on a U-Net model. Based on experiments, it was found that systems using oral care metrics (e.g., “Overbite”, “Overjet” and “Canine Class Relationship” metrics) were at least 2.5% more accurate than systems that did not. Furthermore, training converges more quickly when the oral care metrics are used. Stated another way, the machine learning models trained using oral care metrics tended to be more accurate more quickly (at earlier epochs) than systems which did not. For an existing system observed to have a historical accuracy rate of 91%, an improvement in accuracy of 2.5% reduces the actual error rate by almost 30%.

Examples of oral care metrics include Orthodontic Metrics (OM) and Restoration Design Metrics (RDM). RDM may describe the shape and/or form of one or more 3D representations of teeth for use in dental restoration. One use case example is in the creation of one or more dental restoration appliances. Another use case example is in the creation of one or more veneers (such as a zirconia veneer). Some RDM may quantify the shape and/or other characteristics of a tooth. Other RDM may quantify relationships (e.g., spatial relationships) between two or more teeth. RDM differ from restoration design parameters (RDP) in that restoration design metrics define a current state of a patient's dentition, whereas restoration design parameters serve as specifications to a machine learning or other optimization model to generate desired tooth shapes and/or forms. RDM describe the shapes of the teeth currently (e.g., in a starting or mal condition). Restoration design parameters specify how an oral care provider (such as a dentist or dental technician) intends for the teeth to look after the completion of restoration treatment. Either or both of RDM and RDP may be provided a neural network or other machine learning or optimization algorithm for the purpose of dental restoration. In some implementations, RDM may be computed on the pre-restoration dentition of the patient (i.e., the primary implementation). In other implementations, RDM may be computed on the post-restoration dentition of the patient. A restoration design may comprise one or more teeth and may be referred to as a restoration arch. Restoration design generation may involve the generation of an improved geometry and/or structure of one or more teeth in a restoration arch.

Aspects of RDM calculation are described below. In some implementations, RDM may be measured, for example, through locating landmarks in the teeth (or gums, hardware and/or other elements of the patient's dentition), and the measurements of distances between those landmarks, or otherwise made in relation to those landmarks. In some implementations, one or more neural networks or other machine learning models may be trained to identify or extract one or more RDM from one or more 3D representations of teeth (or gums, hardware and/or other elements of the patient's dentition). Techniques of this disclosure may use RDM in various ways. For instance, in some implementations, one or more neural networks or other machine learning models may be trained to classify or label one or more setups, arches, dentitions or other sets of teeth based at least in part on RDM. As such, in these examples, RDMs form a part of the training data used for training these models.

Aspects of a tooth mesh reconstruction autoencoder may be used in accordance with techniques of this disclosure are described below. An autoencoder for restoration design generation is disclosed in U.S. Provisional Application No. 63/366,514. This autoencoder (e.g., a variational autoencoder or VAE) takes as input a tooth mesh (or other 3D representation) that reflects a mal state (i.e., the pre-restoration tooth shape). The encoder component of the autoencoder encodes that tooth mesh to a latent form (e.g., a latent vector). Modifications may be applied to this latent vector (e.g., based on a mapping of the latent space through prior experiments), for the purpose of altering the geometry and/or structure of the eventual reconstructed mesh. Additional vectors may, in some implementations, be included with the latent vector (e.g., through concatenation), and the resulting concatenation of vectors may be reconstructed by way of the decoder component of the autoencoder into a reconstructed tooth mesh which is a facsimile of the input tooth mesh.

RDM and RDP may also be used as neural network inputs in the execution phase, in accordance with aspects of this disclosure. In some implementations, one or more RDM may be concatenated with the input to the encoder, for the purpose of telling the encoder specific information about the input 3D tooth representation. In some implementations, one or more RDM may be concatenated with the latent vector, before reconstruction, for the purpose of providing the decoder component with specific information about the input 3D tooth representation. Furthermore, in some implementations, one or more restoration design parameters (RDP) may be concatenated with the input to the encoder component, for the purpose of providing the encoder specific information about the input 3D tooth representation. Likewise, in some implementations, one or more restoration design parameters (RDP) may be concatenated with the latent vector, before reconstruction, for the purpose of providing the decoder specific information about the input 3D tooth representation.

In this way, either or both of RDM and RDP may be introduced to the functioning of an autoencoder (e.g., a tooth reconstruction autoencoder), and serve to influence the geometry and/or structure of the reconstructed restoration design (i.e., influence the shape of the tooth on the output of the autoencoder). In some implementations, the variational autoencoder of U.S. Provisional Application No. 63/366,514 may be replaced by a capsule autoencoder (e.g., instead of encoding the tooth mesh to a latent vector, the tooth mesh is encoded to one or more latent capsules).

In some implementations, clustering or other unsupervised techniques may be performed on RDM to cluster one or more setups, arches, dentitions or other sets of teeth based on the restoration characteristics of the teeth. Such clusters may be useful in treatment planning, as the clusters provide insight into categories of patients with different treatment needs. This information may be instructive to clinicians as they learn about possible treatment options. In some instances, best practices may be identified (such as default RDP values) for patient cases that fall into one or another cluster (e.g., as determined by a similarity measure, as in k-NN). After a new case is classified into a particular cluster, information about the relevant best practices may be provided to the clinician who is responsible for processing the case. Such default values may, in some instances, undergo further tuning or modifications.

Case Assignment: Such clusters may be used to gain further insight into the kinds of patient cases which exist in a dataset. Analysis of such clusters may reveal that patient treatment cases with certain RDM values (or ranges of values) may take less time to treat (or alternatively more time to treat). Cases which take more time to treat (or are otherwise more difficult) may be assigned to experienced or senior technicians for processing. Cases which take less time to treat may be assigned to newer or less-experienced techniques for processing. Such an assignment may be further aided by finding correlations between RDM values for certain cases and the known processing durations associated with those cases.

The following RDM may be measured and used in the creation of either or both of dental restoration appliances and veneers {veneers are a type of dental restoration appliance}, with the objective of making the resulting teeth natural looking. Symmetry is generally a preferred facet. There may be differences between patients based on demographic differences. The generation of dental restoration appliances may benefit from some or all of the following RDM. Shade and translucency may pertain, in particular, to the creation of veneers, though some implementations of dental restoration appliances may also consider this information.

Examples of inter-tooth RDM are enumerated below.

1) Bilateral Symmetry and/or Ratios: A measure of the symmetry between one or more teeth and one or more other teeth on opposite sides of the dental. For example, for a pair of corresponding teeth, a measure of the width of each tooth. In one instance, the one tooth is of normal width, and the other tooth is too narrow. In another instance, both teeth are of normal width. The following is a list of attributes that can be measured for a tooth, and compared to the corresponding measurement for one or more corresponding teeth: a) width-mesial to distal distance; b) length-gingival to incisal distance; c) diagonal-distance across the tooth, e.g., from the mesial gingival corner to the distal incisal corner (this measure is one of many that can be used to quantify the shape of teeth beyond length and width). Ratios between a and b may be computed, such as a/b or b/a. Such ratios can be indicative of whether spatial symmetry exists (e.g., by measuring the ratio a/b on the left side and measuring the ratio a/b on the right side, then compare the left and right ratios). In some implementations, where spatial symmetry is “off”, the length, width and/or ratios may not match. Such a ratio may, in some implementations, be computed relative to a standard. A number of esthetic standards are available in the dental literature. Examples include Golden Proportion and Recurring Esthetic Dental Proportion. In some implementations, spatial symmetry may be measured on a pair of teeth, where one tooth is on the right side of the arch, and the other tooth is on the left side of the arch.

2) Proportions of Adjacent Teeth: Measure the width proportions of adjacent teeth as measured as a projection along an arch onto a plane (e.g., a plane that is situated in front of the patient's face). The ideal proportions for use in the final restoration design can be, for example, the so-called golden proportions. The golden proportions relate adjacent teeth, such as central incisors and lateral incisors. This metric pertains to the measuring of these proportions as the proportions exist in the pre-restoration mal dentition. The ideal golden proportions are 1.6, 1, 0.6, for the central incisor, lateral incisor and cuspid, on a particular side (either left or right) for a particular arch (e.g., the upper arch). If one or more of these proportion values is off (e.g., in the case of “peg laterals”), the patient may wish for dental restoration treatment to correct the proportions.

3) Arch Discrepancies: A measure of any size discrepancies between the upper arch and lower arch, for example, pertaining to the widths of the teeth, for the purpose of dental restoration. For example, techniques of this disclosure may make adjacent tooth width proportion measurements in the upper arch and in the lower arch. In some implementations, Bolton analysis measurements may be made by measuring upper widths, lower widths, and proportions between those quantities. Arch discrepancies may be described in absolute measurements (e.g., in mm or other suitable units) or in terms of proportions or ratios, in various implementations.

4) Midline: A measure of the midline of the maxillary incisors, relative to the midline of the mandibular incisors. Techniques of this disclosure may measure the midline of the maxillary incisors, relative to the midline of the nose (if data about nose location is available).

5) Proximal Contacts: A measure of the size (area, volume, circumference, etc.) of the proximal contact between adjacent teeth. In the ideal circumstance, the teeth touch along the mesial/distal surfaces and the gums fill in gingivally to where the teeth touch. Black triangles may form if the gum tissue fails to fill the space below the proximal contact. In some instances, the size of the proximal contact may get progressively shorter for teeth located farther towards the posterior of the arch. In an ideal scenario, the proximal contact would be long enough so that there is an appropriately sized incisal embrasure and the gum tissue fills in the area below or gingival to the contact.

6) Embrasure: In some implementations, techniques of this disclosure may measure the size (area, volume, circumference, etc.) of an embrasure, the gap between teeth at either of the gingival or incisal edge. In some implementations, techniques of this disclosure may measure the symmetry between embrasures on opposite sides of the arch. An embrasure is based at least in part on the length of the length of the contact between teeth, and/or at least in part on the shape of the tooth. In some instances, the size of the embrasure may get progressively longer for teeth located farther towards the posterior of the arch.

Examples of Intra-tooth RDM are enumerated below, continuing with the numbering of other RDM listed above.

7) Length and/or Width: A measure of the length of a tooth relative to the width of that tooth. This metric may reveal, for example, that a patient has long central incisors. Width and length are defined as: a) width—mesial to distal distance; b) length—gingival to incisal distance; c) other dimensions of tooth body—the portions of tooth between the gingival region and the incisal edge. In some implementations, either or both of a length and a width may be measured for a tooth and compared to the length and/or width of one or more teeth.

8) Tooth Morphology: A measure of the primary anatomy of the tooth shape, such as line angles, buccal contours, and/or incisal angles and/or embrasures. The frequency and/or dimensions may be measured. In some implementations, the observed primary tooth shape aspects may be matched to one or more known styles. Techniques of this disclosure may measure secondary anatomy of the tooth shape, such as mamelon grooves. For instance, the frequency and/or dimensions may be measured. In some implementations, the observed secondary tooth shape aspects may be matched to one or more known styles. In some examples, techniques of this disclosure may measure tertiary anatomy of the tooth shape, such as perikymata or striations. For instance, the frequency and/or dimensions may be measured. In some implementations, the observed tertiary tooth shape aspects may be matched to one or more known styles.

9) Shade and/or Translucency: A measure of tooth shade and/or translucency. Tooth shade is often described by the Vita Classical or 3D Master shade guide. Tooth translucency is described by transmittance or a contrast ratio. Tooth shade and translucency may be evaluated (or measured) based on one or more of the following kinds of data pertaining to teeth: the incisal edge, incisal third, body and gingival third. The enamel layer translucency is general higher than the dentin or cementum layer. Shade and translucency may, in some implementations, be measured on a per-voxel (local) basis. Shade and translucency may, in some implementations, be measured on a per-area basis, such as an incisal area, tooth body area, etc. Tooth body may pertain to the portions of the tooth between the gingival region and the incisal edge.

10) Height of Contour: A measure of the contour of a tooth. When viewed from the proximal view, all teeth have a specific contour or shape, moving from the gingival aspect to the incisal. This is referred to as the facial contour of the tooth. In each tooth, there is a height of contour, where that shape is the most pronounced. This height of contour changes from the teeth in the anterior of the arch to the teeth in the posterior of the arch. In some implementations, this measurement may take the form of fitting against a template of known dimensions and/or known proportions. In some implementations, this measurement may quantify a degree of curvature along the facial tooth surface. In some implementations, measure the location along the contour of the tooth where the height of the curvature is most pronounced. This location may be measured as a distance away from the gingival margin or a distance away from the incisal edge, or a percentage along the length of the tooth.

PCT Application with Publication No. WO2020026117A1 is incorporated herein by reference in its entirety. WO2020026117A1 lists some examples of Orthodontic Metrics (OM). Further examples are disclosed herein. The orthodontic metrics may be used to quantify the physical arrangement of an arch of teeth for the purpose of orthodontic treatment (as opposed to restoration design metrics-which pertain to dentistry and describe the shape and/or form of one or more pre-restoration teeth, for the purpose of supporting dental restoration). These orthodontic metrics can measure how badly maloccluded the arch is, or conversely the metrics can measure how correctly arranged the teeth are. In some implementations, the GDL Setups model (or RL Setups, VAE Setups, Capsule Setups, MLP Setups, Diffusion Setups, PT Setups, Similarity Setups and FDG Setups) may incorporate one or more of these orthodontic metrics, or other similar or related orthodontic metrics. In some implementations, such orthodontic metrics may be incorporated into the feature vector for a mesh element, where these per-element feature vectors are provided to the setups prediction network as inputs. In some implementations, such orthodontic metrics may be directly consumed by a generator, an MLP, a transformer, or other neural network as direct inputs (such as presented in one or more input vectors of real numbers S, such as described elsewhere in this disclosure. The use of such orthodontic metrics in the training of the generator may improve the performance (i.e., correctness) of the resulting generator, resulting in predicted transforms which place teeth more nearly in the correct final setups poses than would otherwise be possible. Such orthodontic metrics may be consumed by an encoder structure or by a U-Net structure (in the case of GDL Setups). Such orthodontic metrics may be consumed by an autoencoder, variational autoencoder, masked autoencoder or regularized autoencoder (in the case of the VAE Setups, VAE Mesh Element Labelling, MAE Mesh In-Filling). Such orthodontic metrics may be consumed by a neural network which generates action predictions as a part of a reinforcement learning RL Setups model. Such orthodontic metrics may be consumed by a classifier which applies a label to a setup arch (e.g., labels such as mal, staging or final setup). This description is non-limiting, as the orthodontic metrics may also be incorporated in other ways into the various techniques of this disclosure.

The various loss calculations of the present disclosure may, in some examples, incorporate one or more orthodontic metrics, with the advantage of improving the correctness of the resulting neural network. An orthodontic metric may be used to directly compare a predicted example to the corresponding ground truth example (such as is done with the metrics in the Setups Comparison description). In other examples, one or more orthodontic metrics may be taken from this section and incorporated into a loss computation. Such an orthodontic metric may be computed on the predicted example, and then the orthodontic metric would also be computed on the ground truth example. These two orthodontic metrics results would then be consumed by the loss computation, with the advantage of improving the performance of the resulting neural network. In some implementations, one or more orthodontic metrics pertaining to the alignment of two or more adjacent teeth may be computed and incorporated into a loss function, for example, to train, at least in part, a setups prediction neural network. In some implementations, such an orthodontic metric may promote the network in aligning the mesial surface of one tooth with distal surface of adjacent tooth. Backpropagation is an exemplary algorithm by which a neural network may be trained using one or more loss values.

In some implementations, one or more orthodontic metrics may be used to evaluate the predicted output of a neural network, such as a setups prediction. Such a metric(s) may enable the training algorithm to determine how close the predicted output is to an acceptable output, for example, in a quantified sense. In some implementations, this use of an orthodontic metric may enable a loss value to be computed which does not depend entirely on a comparison to a ground truth. In some implementations, such a use of an orthodontic metric may enable loss calculation and network training to proceed without the need for a comparison against a ground truth example. The advantage of such an approach is that loss may be computed based on a general principle or specification for the predicted output (such as a setup) rather than tying loss calculation to a specific ground truth example (which may have been defined by a particular doctor, clinician, or technician, whose treatment philosophy may differ from that of other technicians or doctors). In some implementations, such an orthodontic metric may be defined based on a FID (Frechet Inception Distance) score.

The following is a description of some of the orthodontic metrics which are used to quantify the state of a set of teeth in an arch for the purpose of orthodontic treatment. These orthodontic metrics indicate the degree of malocclusion that the teeth are in at a given stage of clear tray aligner treatment.

An orthodontic metric that can be computed using tensors may be especially advantageous when training one of the neural networks of the present disclosure, because tensor operations may promote efficient computations. The more efficient (and faster) the computation, the faster the rate at which training can proceed.

In some examples, an error pattern may be identified in one or more predicted outputs of an ML model (e.g., a transformation matrix for a predicted tooth setup, a labelling of mesh elements for mesh cleanup, an addition of mesh elements to a mesh for the purpose of mesh in-filling, a classification label for a setup, a classification label for a tooth mesh, etc.). One or more orthodontic metrics may be selected to become an input to the next round of ML model training, to address any pattern of errors or deficiencies which may be identified in the one or more predicted outputs.

Some OM may be defined relative to an archfrom coordinate frame, the LDE coordinate system. In some implementations, a point may be described using an LDE coordinate frame relative to an archform, where L, D and E correspond to: 1) Length along the curve of the archform, 2) Distance away from the archform, and 3) distance in the direction perpendicular to the L and D axes (which may be termed Eminence), respectively.

Various of the OM and other techniques of the present disclosure may compute collisions between 3D representations (e.g., of oral care objects, such as teeth). Such collisions may be computed as at least one of: 1) penetration distance between 3D tooth representations, 2) count of overlapping mesh elements between 3D tooth representations, and 3) volume of overlap between 3D tooth representations. In some implementations, an OM may be defined to quantify the collision of two or more 3D representations of oral care structures, such as teeth. Some optimization algorithms, such as setups prediction techniques, may seek to minimize collisions between oral care structures (such as teeth).

Between-arch orthodontic metrics are as follows.

Six (6) metrics for the comparison of two or more arches are listed below. Other suitable comparison orthodontic metrics are found elsewhere in this disclosure, such as in the section for the Setups Comparison technique.
1. Rotation geodesic distance (rotation between predicted example and ground truth setup example)
2. Translation distance (gap between predicted example and ground truth setup example)
3. Normalized translation distance
4. 3D alignment error that measures the distance between predicted mesh elements and ground truth mesh elements, in units of mm.
5. Normalized 3D alignment
6. Percent overlap (% overlap) by volume (alternatively % overlap by mesh elements) of predicted example and corresponding ground truth example

Within-arch orthodontic metrics are as follows.
Alignment—A 3D tooth orientation vector may be calculated using the tooth's mesial-distal axis. A 3D vector, which may be tangent vector to the archform at the position of the tooth may also be calculated. The XY components (i.e., which may be 2D vectors) may then be used to compare the orientation of the archform at the tooth's location to the tooth's orientation in XY space. Cosine similarity may be used to calculate the 2D orientation difference (angle) between the archform tangent and the tooth's mesial-distal axis.
Arch Symmetry—For each left-right pair of teeth (e.g., lower left lateral incisor and/or lower right lateral incisor) the absolute difference may be calculated between each tooth's X-coordinate and the global coordinate reference frame's X-axis. This delta may indicate the arch asymmetry for a given tooth pair. The result of such a calculation may be the mean X-axis delta of one or more tooth-pairs from the arch. This calculation may, in some implementations, be performed relative to the Y-axis with y-coordinates (and/or relative to the Z axis with Z-coordinates).
Archform D-axis Differences—May compute the D dimension difference (i.e., the positional difference in the facial-lingual direction) between two arch states, for one or more teeth. May, in some implementations, return a dictionary of the D-direction tooth movement for each tooth, with tooth UNS number as the key. May use the LDE coordinate system relative to an archform.
Archform (Lower) Length Ratio—May compute the ratio between the current lower arch length and the arch length as it was in the original maloccluded lower arch.
Archform (Upper) Length Ratio—May compute the ratio between the current upper arch length and the arch length as it was in the original maloccluded upper arch.
Archform Parallelism (Full arch)—For at least one local tooth coordinate system origin in the upper arch, the one or more nearest origins (e.g., tooth local coordinate system origins) in the lower arch. In some implementations, the two nearest origins may be used. May compute the straight line distance from the upper arch point to the line formed between the origins of the two teeth in the opposing (lower) arch. May return the standard deviation of the set of “point-to-line” distances mentioned above, where the set may be composed of the point-to-line distances for each tooth in the arch.
Archform Parallelism (Individual tooth)—This metric may share some computational elements with the archform_parallelism_global orthodontic metric, except that this metric may input the mean distance from a tooth origin to the line formed by the neighboring teeth in opposing arches (e.g., a tooth in the upper arch and the corresponding tooth in the lower arch). The mean distance may be computed for one or more such pairs of teeth. In some implementations, this may be computed for all pairs of teeth. Then the mean distance may be subtracted from the distance that is computed for each tooth pair. This OM may yield the deviation of a tooth from a “typical” tooth parallelism in the arch.
Buccolingual Inclination—For at least one molar or premolar, find the corresponding tooth on the opposite side of the same arch (i.e., for a tooth on the left side of the arch, find the same type of tooth on the right side and vice versa). This OM may compute an n-element list for each tooth (e.g. n may equal 2). This list may contain at least the tooth IDs of the teeth in each pair of teeth (e.g., LeftLowerFirstMolar and RightLowerFirstMolar in a list=[left_tooth_idx_1, right_tooth_idx_2]). Such an n-element vector may be computed for each molar and each premolar in the upper and lower arches. The buccal cusps may be identified on the molars and premolars on each of the left and right sides of the arch. Draw a line between the buccal cusps of the left tooth and the buccal cusps on the right tooth. Make a plane using this line and the z-axis of the arch. The lingual cusps may be projected onto the plane (i.e., at this point the angle of inclination may be determined). By performing an additional projection, the approximate vertical distance between the lingual cusps and the buccal cusps may be computed. This distance may be used as the buccolingual inclination OM.
Canine Overbite—The upper and lower canines may be identified. The first premolar for the given side of the mouth may be identified. On a given side of the arch, a distance may be computed between the upper canine and the lower canine, and also between the upper pre-molar and the lower pre-molar. The average (or median, or mode or some other statistic) may be computed for the measured distances. The z-component of this result indicates the degree of overbite. Overbite may be computed between any tooth in one arch and the corresponding tooth in the other arch.
Canine Overjet Contact—May calculate the collisions (e.g., collision distances) between pairs of canines on opposing arches.
Canine Overjet Contact KDE—May take an orthodontic metric score for the current patient case as input, and may convert that score into to a log-likelihood using a previously trained kernel density estimation (KDE) model or distribution. This operation may yield information about where in the distribution of “typical” values this patient case lies.
Canine Overjet—This OM may share some computational steps with the canine overbite OM. In some implementations, average distances may be computed. In some implementations, the distance calculation may compute the Euclidean distance of the XY components of a tooth in the upper arch and a tooth in the lower arch, to yield overjet (i.e., as opposed to computing the difference in Z-components, as may be performed for canine overbite). Overjet may be computed between any tooth in one arch and the corresponding tooth in the other arch.
Canine Class Relationship (also applies to first, second and third molars)—This OM may, in some implementations comprise two functions (e.g., written in Python).
   get_canine_landmarks( ): Get landmarks for each tooth which may be used to compute the class relationship, and then, in some implementations, map those landmarks onto the global coordinate space so that measurements may be made between teeth.
   class_relationship_score_by_side( ): May compute the average position of at least one landmark on at least one tooth in the lower arch, and may compute the same for the upper arch. Then may compute the vector from the upper arch landmark position to the lower arch landmark position, and finally projects this vector onto the lower arch to yield a quantification (e.g., as a scalar) of the amount of delta in “arch 1-axis” position there is. This OM may compute how far forward or behind the tooth is positioned on the 1-axis relative to the tooth or teeth of interest in the opposing arch.
Crossbite—Fossa in at least one upper molar may be located by finding the halfway point between distal and mesial marginal ridge saddles of the tooth. A lower molar cusp may lie between the marginal ridges of the corresponding upper molar. This OM may compute a vector from the upper molar fossa midpoint to the lower molar cusp. This vector may be projected onto the d-axis of the archform, yielding a lateral measure of distance from the cusp to the fossa. This distance may define the crossbite magnitude.
Edge Alignment—This OM may identify the leftmost and rightmost edges of a tooth, and may identify the same for that tooth's neighbor.
   The OM may then draw a vector from the leftmost edge of the tooth to the leftmost edge of the tooth's neighbor.
   The OM may then draw a vector from the rightmost edge of the tooth to the rightmost edge of the tooth's neighbor.
   The OM may then calculates the linear fit error between the two vectors.
   Such a calculation may involve making two vectors:
   Vec_tooth=right_tooths_leftside to left_tooths_leftside
   Vec_neighbor=right_tooths_rightside to left_tooths_leftside
   And then may involve computing the dot-product of these two vectors and subtracting the result from 1. (i.e., EdgeAlignment score=1−abs(dot (Vec_tooth, Vec_neighbor))).
   A score of 0 may indicate perfect alignment. A score of 1 may mean perpendicular alignment.
Incisor Interarch Contact KDE—May identify the deviation of the IncisorInterarchContact from the mean of a modeled distribution of such statistics across a dataset of one or more other patient cases.
Leveling—May compute a measure of leveling between a tooth and its neighbor. This OM may calculate the difference in height between two or more neighboring teeth. For molars, this OM may use the midpoint between the mesial and distal saddle ridges as the height of the molar. For non-molar teeth, this OM may use the length of the crown from gums to tip. In some implementations, the tip may be the origin of the local coordinate space of the tooth. Other implementations may place the origin in other locations. A simple subtraction between the heights of neighboring teeth may yield the leveling delta between the teeth (e.g., by comparing Z components).
Midline—May compute the position of the midline for the upper incisors and/or the lower incisors, and then may compute the distance between them.
Molar Interarch Contact KDE—May compute a molar interarch contact score (i.e., a collision depth or other type of collision), and then may identify where that score lies in a pre-defined KDE (distribution) built from representative cases.
Occlusal Contacts—For a particular tooth from the arch, this OM may identify one or more landmarks (e.g., mesial cusp, or central cusp, etc.). Get the tooth transform for that tooth. For each cusp on the current tooth, the cusp may be scored according to how well the cusp contacts the neighboring (corresponding) tooth in the opposite arch. A vector may be found from the cusp of the tooth in question to the vertical intersection point in the corresponding tooth of the opposing arch. The distance and/or direction (i.e., up or down) to the opposing arch may be computed. A list may be returned that contains the resulting signed distances, one for each cusp on the tooth in question.
Overbite—The upper and lower central incisors may be compared along the z-axis. The difference along the z-axis may be used as the overbite score.
Overjet—The upper and lower central incisors may be compared along the y-axis. The difference along the y-axis may be used as the overjet score.
Molar Interarch Contact—May calculate the contact score between molars, and may use collision measurement(s) (such as collision depth).
Root Movement d—The tooth transforms for an initial state and a next state may be received. The archform axes at a point L along the archform may be computed. This OM may return a distance moved along the d-axis. This may be accomplished by projecting the root pivot point onto the d-axis.
Root Movement1—The tooth transforms for an initial state and a next state may be received. The archform axes at a point L along the archform may be computed. This OM may return a distance moved along the 1-axis. This may be accomplished by projecting the root pivot point onto the 1-axis.
Spacing—May compute the spacing between each tooth and its neighbor. The transforms and meshes for the arch may be received. The left and right edges of each tooth mesh may be computed. One or more points of interest may be transformed from local coordinates into the global arch coordinate frame. The spacing may be computed in a plane (e.g., the XY plane) between each tooth and its neighbor to the “left”. May return an array of one or more Euclidean distances (e.g., such as in the XY plane) which may represent the spacing between each tooth and its neighbor to the left.
Torque—May compute torque (i.e., rotation around and axis, such as the x-axis). For one or more teeth, one or more rotations may be converted from Euler angles into one or more rotation matrices. A component (such as a x-component) of the rotations may be extracted and converted back into Euler angles. This x-component may be interpreted as the torque for a tooth. A list maybe returned which contains the torque for one or more teeth, and may be indexed by the UNS number of the tooth.

Some techniques of the present disclosure, for example the setups comparison technique, and the setups prediction techniques (e.g., such as GDL Setups, MLP Setups, VAE Setups and the like), may benefit from a processing step which may align (or register) arches of teeth (e.g., where a tooth may be represented by a 3D point cloud, or some other type of 3D representation described herein). Such a processing setup may, for example, be used to register a ground truth setup arch from a patient case with the maloccluded arch from that same case, before these mal and ground truth setup arches are used to train a setups prediction neural network model. Such a step may aid in loss calculation, because the predicted arch (e.g., an arch outputted by a generator) may be in better alignment with the ground truth setup arch, a condition which may facilitate the calculation of reconstruction loss, representation loss, L1 loss, L2 loss, MSE loss and/or other kinds of losses described herein. In some implementations, an iterative closest point (ICP) technique may be used for such registration. ICP may minimize the squared errors between corresponding entities, such as 3D representations. In some implementations, linear least squares calculations may be performed. In some implementations, non-linear least squares calculations may be performed. Various registration models may incorporate portions of the following algorithms, in whole or in part: Levenberg-Marquardt ICP, Least Square Rigid transformation, Robust Rigid transformation, random sample consensus (RANSAC) ICP, K-means based RANSAC ICP and Generalized ICP (GICP). Registration may, in some instances, help decrease the subjectivity and/or randomness that may, in some instances, occur in reference ground truth setup designs which have been designed by technicians (i.e., two technicians may produce different but valid final setups outputs for the same case) or by other optimization techniques.

The mesh comparison module may compare two or more meshes, for example for the computation of a loss function or for the computation of a reconstruction error. Some implementations may involve a comparison of the volume and/or area of the two meshes. Some implementations may involve the computation of a minimum distance between corresponding vertices/faces/edges/voxels of two meshes. For a point in one mesh (vertex point, mid-point on edge, or triangle center, for example) compute the minimum distance between that point and the corresponding point in the other mesh. In the case that the other mesh has a different number of elements or there is otherwise no clear mapping between corresponding points for the two meshes, different approaches can be considered. For example, the open-source software packages CloudCompare and MeshLab each have mesh comparison tools which may play a role in the mesh comparison module for the present disclosure. In some implementations, a Hausdorff Distance may be computed to quantify the difference in shape between two meshes. The open-source software tool Metro, developed by the Visual Computing Lab, can also play a role in quantifying the difference between two meshes. The following paper describes the approach taken by Metro, which may be adapted by the neural networks applications of the present disclosure for use in mesh comparison and difference quantification: “Metro: measuring error on simplified surfaces” by P. Cignoni, C. Rocchini and R. Scopigno, Computer Graphics Forum, Blackwell Publishers, vol. 17(2), June 1998, pp 167-174.

Some techniques of this disclosure may incorporate the operation of, for one or more points on the first mesh, shooting a ray normal to the mesh surface and calculating the distance before that ray is incident upon the second mesh. The lengths of the resulting line segments may be used to quantify the distance between the meshes. According to some techniques of this disclosure, the distance may be assigned a color based on the magnitude of that distance and that color may be applied to the first mesh, by way of visualization.

The setups comparison techniques of this disclosure may involve one or more of visual comparison and metrics-based quantitative comparison capabilities. Such metrics may be referred to as “comparison metrics” herein. Generally speaking, systems of this disclosure may be configured to compare two or more setups. The comparison techniques of this disclosure can be used to compare the output of a first setups prediction model to the corresponding ground truth setup (or to the corresponding malocclusion). The comparison techniques of this disclosure may be configured to compare the output of a second setups prediction model to the corresponding ground truth setup (or to the corresponding malocclusion). The results of these comparisons may be used to determine whether one of the first or second setups prediction methods is superior to the other (in the context of a given domain of training data), and thereby determine which setups prediction method is best suited to a production environment. In some instances, two or more setups which have been generated by setups prediction models may be compared to each other. Such a comparison may enable an informed choice of setup for use in generating an orthodontic appliance, such as a clear tray aligner (CTA).

Setups comparison metrics and/or visualizations of this disclosure may be applied to final setups (i.e., arrangements of teeth where the teeth are in their final poses at the end of treatment), and/or setups comparison metrics and/or visualizations of this disclosure may be applied to intermediate stages (i.e., intermediate arrangements of teeth, where the teeth are in poses that correspond to in-progress treatment, before the teeth reach their final poses).

The functionality of comparing setups, such as S2 and S3, provides one or more technical advantages. For example, a clinician may assess the accuracy and/or suitability of a setups prediction method using such a comparison. In other examples, a new clinician can be trained to recognize proper final setups and intermediate staging design based on viewing and analyzing the output of such a comparison. Such a comparison may be introduced to an oral care appliance fabrication method as a means of validating the correctness of a final setup or an intermediate stage to be used in oral care treatment, such as with indirect bonding trays or clear tray aligners. The following is a description of examples for such comparison.

Portions of the iterative closest point (ICP) algorithm can be adapted for use by a comparison module for the comparison of two or more orthodontic setups, particularly the portion of ICP that entails computing distances between corresponding vertices in two meshes. In some implementations, a distance D1 is computed between each pair of corresponding vertices between a first tooth in S2 and the corresponding tooth in S3. The distance values for the first tooth are averaged, and the result is outputted by the comparison module. The comparison module performs the same operation for each pair of corresponding teeth between S2 and S3.

The distance D1 may be a Euclidean distance (L2 norm). In other implementations, the distance D1 may be computed by a polynomial absolute operation (such as with an L1 norm). In other implementations, D1 may be a Hamming distance, a Manhattan distance or a Minkowski distance.

In other implementations, instead of computing a distance between corresponding vertices, the comparison module of this disclosure may compute a cosine angle between corresponding face normal vectors. An angle A1 is computed between the normal vectors of corresponding faces of a first tooth in S2 and the corresponding tooth in S3. The angle values for the first tooth are averaged, and the result is outputted by the comparison module. The comparison module performs the same operation for each pair of corresponding teeth between S2 and S3. An angle A1 for a single pair of corresponding normal vectors is computed by computing the dot product of the two normal vectors and the computing the arccos( ) of that dot product. In some implementations, an averaged dot product may be computed over all pairs of corresponding normal vectors between S2 and S3. Then a final arccos( ) operation can be applied to the averaged dot product. Example pseudocode for this cosine similarity angle computation is as follows:

```
dot_product_sum = 0.0
for ii in range(0, len(setup_normals)):
  dot_product = np.dot(setup_normals[ii], predicted_normals[ii])
  dot_product_sum = dot_product_sum + dot_product
average_dot_product = dot_product_sum / len(setup_normals)
average_angle_degrees = math.acos(average_dot_product) * 180.0 /
math.pi
```

For example, the predicted upper right central incisor has a measured distance of 1.591 mm away from the ground truth setup upper right central incisor. The predicted and ground truth setup versions of this tooth have a 5.338-degree cosine angle difference. In some implementations, a geodesic distance can be computed to compare the predicted and ground truth transforms (coordinate systems) for a tooth, in terms of angle difference. An angular difference is computed between the axes of the ground truth coordinate system, and the predicted coordinate system. A geodesic distance may use an arccos( ) function to compute an angle. In some implementations the teeth in an arch may have roots. In other implementations, the teeth in an arch do not have roots. In other implementations, the extent of overlaps between meshes can be quantified. In some implementations, the count of overlapping mesh elements between S2 and S3 can be counted. Mesh elements may include vertices, edges and faces. In other implementations, the 3D volume of overlap between S2 and S3 can be computed. In other implementations, the overlapping surface areas of S2 and S3 can be computed.

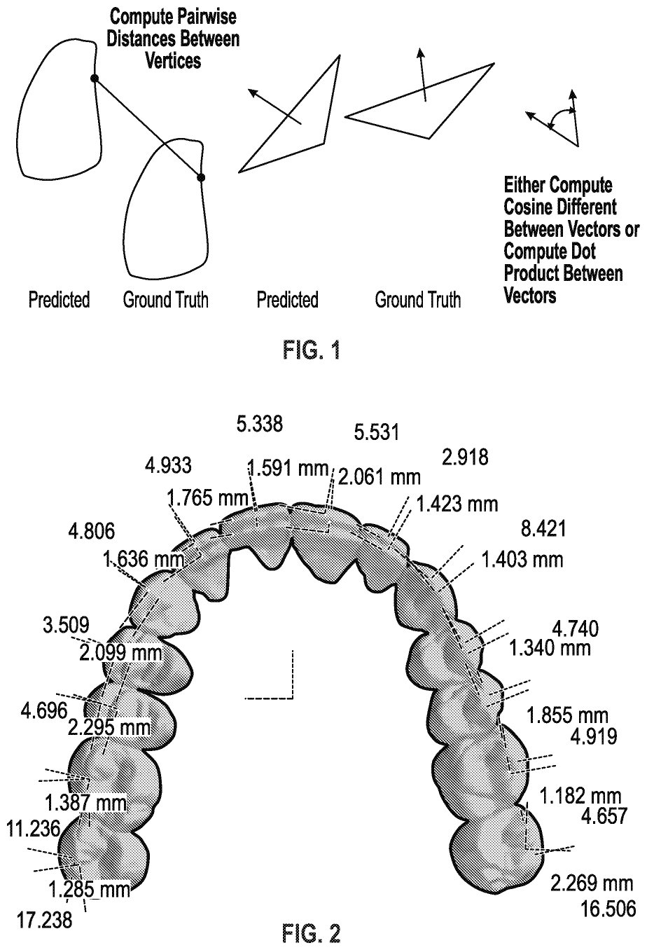

FIG. 1 illustrates techniques for measuring the difference between tooth meshes, in accordance with aspects of this disclosure. FIG. 2 illustrates an output of a 3D viewer in the comparison tool, with the output showing the predicted arch S3 in yellow and the ground truth setup arch S2 in white. The comparison tool can be configured to display visualizations (see FIG. 2) that describe the relative geometries of two or more dental arches. The screenshot from the 3D viewer in the comparison tool as shown in FIG. 2 shows the predicted arch and the ground truth setup arch S2. These arches are superimposed in the same 3D viewer space for comparison. There are statistics shown next to each pair of teeth: the Euclidean distance metric is shown nearest to the teeth, and the cosine angle metric is farther out. FIG. 1 further illustrates the Euclidean distance and cosine angle metrics.

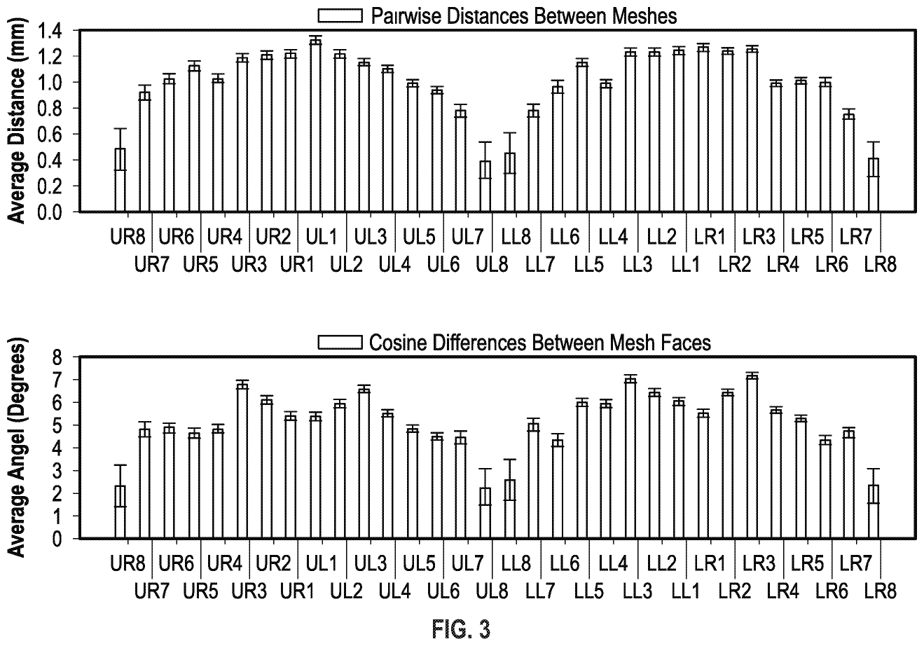

The comparison module can be configured to output aggregate comparison statistics over a large dataset of patient cases. The top histogram of FIG. 3 shows the result of using the Euclidean distance-based comparison technique over 2975 patient cases.

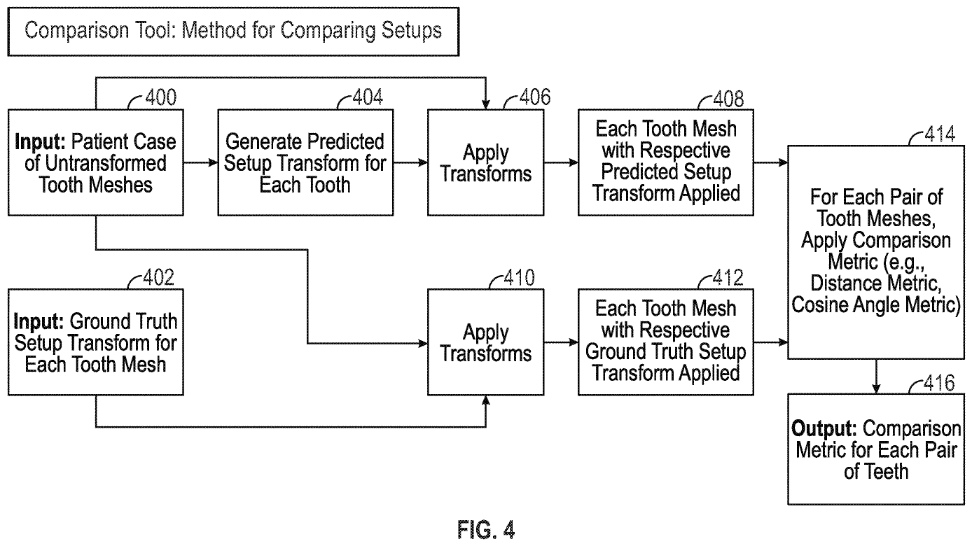

The following bottom histogram of FIG. 3 shows the result of using the Cosine angle-based comparison technique over 2975 patient cases. FIG. 4 shows a method that describes the operation of the comparison tool. In some implementations, a patient case comprising tooth meshes in a pre-transformation state 400 may be received at the input. The systems of this disclosure may apply (410) ground truth setups transforms 402 (e.g., final setups or intermediate stages) to the tooth meshes 400. A setups prediction neural network (or other ML model) may generate predicted setups transforms for the teeth 400 (404). Systems of this disclosure may apply (406) one or more of the predicted transforms. The predicted setup 408 and the ground truth setup 412 may be provided to the setups comparison metric computation module 414, the results of which are sent to the output 416 (e.g., a vector of comparison metric values—such as for corresponding teeth).

Other setups comparison metrics that the comparison tools of this disclosure may include, but are not limited to, one or more of the following:
Rotation-geodesic distance: Compute the geodesic distance between two rotations or frames in terms of angle difference. For example, compute the geodesic distance between a rotation for a tooth in S2 and a rotation for a tooth in S3. Reference-Metrics for 3D Rotations: Comparison and Analysis (http://www.cs.cmu.edu/~cga/dynopt-19/readings/Rmetric.pdf).
Translation-Dis: The L2-distance between the origins of two transformations or coordinate frames. For example, compute the L2-distance between the origin of a tooth in S2 and the origin of a tooth in S3.
Translation-Relative-Dist: Translation-Dis normalized by mesh diameter of the input mesh. Diameter is the maximum L2-distance of mesh points from their center of mass multiplied by 2. For example, compute the Translation-Dis normalized by mesh diameter between a tooth in S2 and a tooth in S3.
3D-Alignment-Err: The average L2-distance between points of the predicted (S3) and target (S2) meshes.
3D-Alignment-Err-Normalized: 3D-Alignment-Err which has been normalized by mesh diameter.

Mesh diameter is the L2-distance or normalized L2-distance between mesh points in 3D spaces from the centroid of the mesh. In some examples, a direct comparison can be made between two tooth transforms using a categorical cross entropy loss (e.g., the transforms for S2 and S3). A cross entropy can be computed between two transformation matrices: [15 deg, 0.1 mm] vs [20 deg, 0.15 mm]. In some examples, a mesh can be represented as a graph, and in other examples as a sparse tensor (i.e., a point cloud). A loss can be computed between the sparse tensors corresponding to S2 and S3.

A setups comparison metric may, in some implementations, be used by an RL Setups model of this disclosure. In some implementations, quantifying the error between the predicted next state and the ground truth target state (e.g., the state that has been approved by a doctor) may aid in the formulation of orthodontic treatment of a patient. A setups comparison metric may be used in such a case. More generally, a setups comparison metric may be used to compare any RL state to any other RL state.

3D oral care representations are described herein as such because 3-dimensional representations are currently state of the art. Nevertheless, 3D oral care representations are intended to be used in a non-limiting fashion to encompass any representations of 3-dimensions or higher orders of dimensionality (e.g., 4D, 5D, etc.), and it should be appreciated that machine learning models can be trained using the techniques disclosed herein to operate on representations of higher orders of dimensionality.

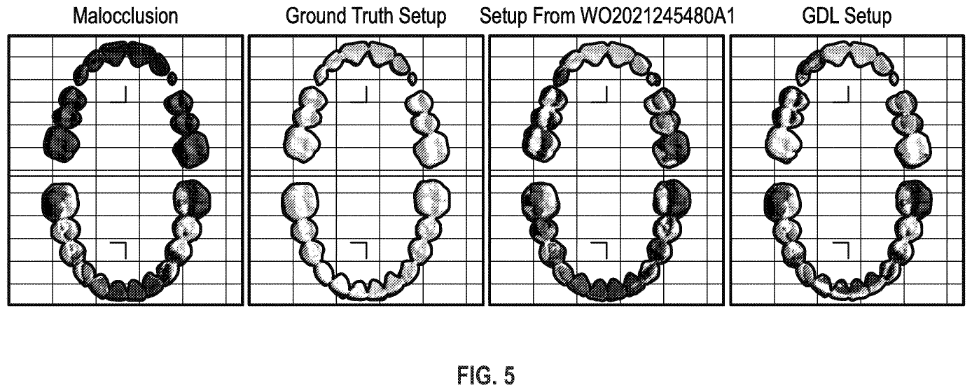

FIG. 5 illustrates a setups comparison visualization of this disclosure. FIG. 5 shows three (3) setups relative to the ground final truth setup. The left-most visualization shows the malocclusion setup relative to the ground final truth setup. The third visualization shows a predicted final setup (from the technique described in WO2021245480A1) compared to the ground truth final setup. The fourth visualization shows a predicted final setup from the GDL Setups technique (described herein) relative to the ground truth final setup.

The setups comparison techniques of the present disclosure may, in some implementations, be used to compare two or more dental restoration arches, such as a pre-restoration arch and a post-restoration arch. In some implementations, such arches may be shown side-by-side. In some implementations, such arches may be shown superimposed on each other, possibly with the use of an alpha channel or other transparency mechanism so that one arch can be seen within the other arch.

In some implementations, the oral care metrics described herein may be computed for a first setup and also for a second setup, and compared as a means of comparing the setups. A vector of oral care metrics (e.g., comprising restoration design metrics or orthodontic metrics) may be computed for each of a first setup and a second setup. Those vectors of oral care metrics (e.g., “Alignment”, “Canine Overjet”, “Midline”, “Bilateral Symmetry and/or Ratios”, “Arch Discrepancies”, among others described herein) may be compared, for example, by computing L1, L2, MSE or other vector comparison techniques described herein.

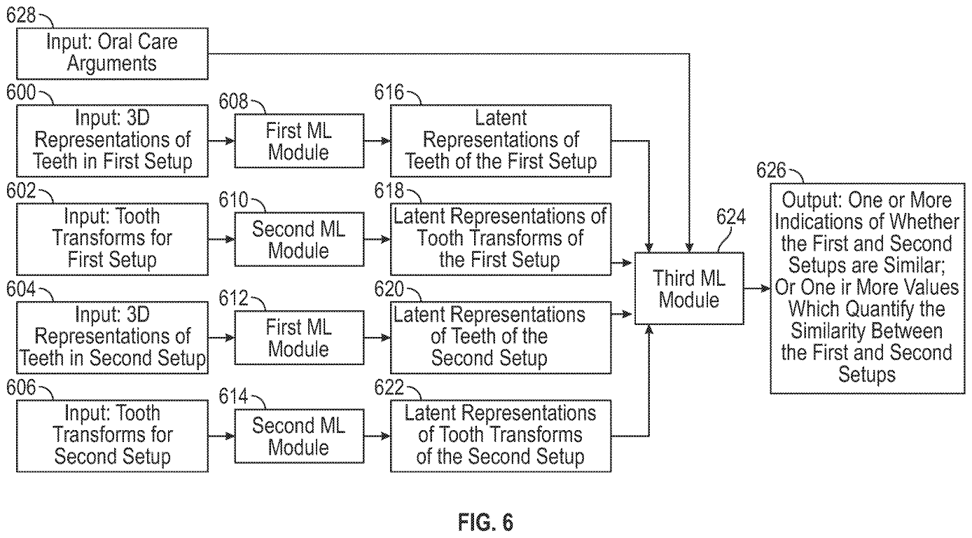

FIG. 6 describes a machine learning (ML) method to compare two or more setups.

In some implementations, 3D representations of the patient's teeth from the first setup 600 may be provided to a first ML module 608, which may be trained to generate latent representations of the patient's teeth 616.

In some implementations, 3D representations of the patient's teeth from the second setup 604 may be provided to a first ML module 612 (which may be the same as first ML module 608), which may be trained to generate latent representations of the patient's teeth 620.

A first ML module 608 (or 612) may contain one or more hierarchical neural network feature extraction modules (HNNFEM), one or more encoders—such as from a reconstruction autoencoder, one or more transformer encoders, one or more transformer decoders, or one or more modules of convolution and pooling layers. A HNNFEM (e.g., an encoder-decoder structure—such as a U-Net, a pyramid encoder-decoder, or a 3D SWIN transformer) may be trained to generate multi-scale voxel (or point) embeddings of a 3D representation (or multi-scale embeddings of other mesh elements described herein). For example, a HNNFEM of one or more layers (or levels) may be trained on 3D representations of patient dentitions to generate neural network feature embeddings which encompass global, intermediate or local aspects of the 3D representation of the patient's dentition.

In some implementations, tooth transforms of the first setup 602 may be provided to a second ML module 610 (e.g., one or more encoders-such as from a reconstruction autoencoder, one or more transformer encoders, one or more transformer decoders, or one or more modules of convolution and pooling layers), which may be trained to generate latent representations of the tooth transforms of the first setup 618 (e.g., which may place the patient's teeth into malocclusion poses, intermediate poses, or final setup poses).

In some implementations, tooth transforms of the second setup 606 may be provided to a second ML module 614 (which may be the same as second ML module 610), which may be trained to generate latent representations of the tooth transforms of the second setup 622 (e.g., which may place the patient's teeth into malocclusion poses, intermediate poses, or final setup poses).

The latent representations (616 and 620) generated by the first ML modules and the latent representations (618 and 622) generated by the second ML modules may be provided to a third ML module 624, which may be trained to compare the first and second setups. The third ML module (e.g., one or more MLPs—such as a set of four fully connected layers, one or more transformer encoders, or one or more transformer decoders, or other architectures described herein) may be trained to generate an indication 626 of whether the first setup and the second setup are substantially similar.

Oral care arguments 628 may, in some implementations, be provided to the third ML module 624 to influence the setups comparison operation. The third ML module 624 may be trained, at least in part by one or more loss values, which may compare predicted outputs to corresponding ground truth representations. For example, each example in the training dataset may contain a first setup, a second setup, and also one or more ground truth labels (e.g., which may describe or quantify a comparison between the two setups). Non-limiting values of one such predicted label includes: “similar”, or “not similar”. Non-limiting values of another such predicted label includes: “both are final setup”, “both are intermediate”, “both are malocclusion”, “setups are different”.

In some implementations, the third ML module 624 may generate one or more real values which quantify the magnitude of a difference between two setups. The one or more values may correspond to a difference in oral care metric value between the first setup and the second setup. These differences in oral care metrics values can be compared against ground truth values and be used in loss calculation. The ground truth values may be generated by computing the oral care metrics for each of the first setup and the second setup, and then subtracting the respective oral care metrics values, generating a vector of difference values. The third ML model may be trained to generate a predicted vector of these difference values. Examples of such oral care metrics include “Alignment”, “Canine Overjet”, “Midline”, “Bilateral Symmetry and/or Ratios”, “Arch Discrepancies”, or others described herein. Cross entropy loss, among others disclosed herein, may be used to quantify the difference between the predicted difference vector and the ground truth difference vector. The loss may be used to train, at least in part, any of the first ML module, the second ML module, or the third ML module. In some implementations, loss may quantify a difference between the predicted and ground truth labels, and be used to train, at least in part, the neural networks of this disclosure.

In some implementations, the representation generation neural networks of the first ML module and of the second ML module may implement reconstruction autoencoders. The reconstruction autoencoders may be trained, at least in part, by loss values, such as KL-Divergence loss, reconstruction loss or others described herein.

1. A method of comparing orthodontic setups, the method comprising:
receiving, by processing circuitry of a computing device, an instant orthodontic setup; and
receiving, by the processing circuitry, a reference orthodontic setup, wherein each of the instant orthodontic setup and the reference orthodontic setup comprises a respective three-dimensional (3D) representation of one or more teeth;
comparing, by the processing circuitry, at least one aspect of the instant orthodontic setup and at least one corresponding aspect of the reference orthodontic setup to compute a comparison metric; and
outputting, by the processing circuitry, the comparison metric.

2. The method of claim 1, wherein outputting the comparison metric comprises providing the comparison metric as feedback to a machine learning (ML) model that generated the instant orthodontic setup.

3. The method of claim 1, wherein outputting the comparison metric comprises providing the comparison metric to an optimizer that is configured to implement iterative changes to an input orthodontic setup.

4. The method of claim 1, wherein the instant orthodontic setup represents one or more teeth in transformed poses.

5. The method of claim 1, wherein the instant orthodontic setup represents one or more teeth at an origin of a global coordinate space, the method further comprising applying one or more tooth transforms to the instant orthodontic setup prior to computing the comparison metric.

6. The method of claim 1, wherein the comparison metric is used to generate an orthodontic appliance design.

7. The method of claim 1, wherein computing the comparison metric comprises computing the comparison metric using an iterative closest point (ICP)-based technique.

8. The method of claim 1, wherein each of the aspect of the instant orthodontic mesh and the corresponding aspect of the reference orthodontic mesh comprises a respective mesh element.

9. The method of claim 1, wherein computing the comparison metric comprises calculating an angular distance between a vector of the instant orthodontic setup and a corresponding vector of the reference orthodontic setup.

10. The method of claim 9, wherein each of the vector and the corresponding vector comprises at least one respective coordinate axis.

11. The method of claim 9, wherein the angular difference comprises a cosine difference.

12. The method of claim 9, wherein the angular difference comprises a dot product.

13. The method of claim 1, wherein the computing device is deployed at a clinical context, and wherein the method is performed in near real-time during an encounter with a patient.

14. A device for comparing orthodontic setups, the device comprising:
interface hardware configured to receive an instant orthodontic setup a reference orthodontic setup, wherein each of the instant orthodontic setup and the reference orthodontic setup comprises a respective three-dimensional (3D) representation of one or more teeth;
processing circuitry configured to compare at least one aspect of the instant orthodontic setup and at least one corresponding aspect of the reference orthodontic setup to compute a comparison metric; and
a memory unit configured to store the comparison metric.

15. The device of claim 14, wherein the processing circuitry is further configured to provide, via the interface hardware, the comparison metric as feedback to a machine learning (ML) model that generated the instant orthodontic setup.

16. The device of claim 14, wherein the processing circuitry is further configured to provide, via the interface hardware, the comparison metric to an optimizer that is configured to implement iterative changes to an input orthodontic setup.

17. The device of claim 14, wherein the instant orthodontic setup represents one or more teeth in transformed poses.

18. The device of claim 14, wherein the instant orthodontic setup represents one or more teeth at an origin of a global coordinate space, and wherein the processing circuitry is further configured to apply one or more tooth transforms to the instant orthodontic setup prior to computing the comparison metric.

19. The device of claim 14, wherein the comparison metric is used to generate an orthodontic appliance design.

20. The device of claim 14, wherein computing the comparison metric comprises computing the comparison metric using an iterative closest point (ICP)-based technique.
